(19) United States
(12) Patent Application Publication
(10) Pub. No.: US 2012/0188515 A1
(43) Pub. Date: Jul. 26, 2012

(54) PROJECTOR HAVING LASER LIGHT SOURCE

(75) Inventor: YUNG-LUN HUANG, Tu-Cheng (TW)

(73) Assignee: HON HAI PRECISION INDUSTRY CO., LTD., Tu-Cheng (TW)

(21) Appl. No.: 13/118,570

(22) Filed: May 30, 2011

(30) Foreign Application Priority Data
Jan. 26, 2011 (TW) 100102775

(51) Int. Cl. G03B 21/14

(52) U.S. Cl. 353/31; 353/38

(57) ABSTRACT

A projector includes at least one laser light source and at least one optical component. Each laser light source is configured to emit light beams. Each optical component includes a magnifying element, a homogenizing element, and a Fresnel lens. The magnifying element is positioned adjacent to a corresponding one of the at least one laser light source and configured to magnify the light beams from the corresponding laser light source. The homogenizing element is configured to homogenize the light beams from the magnifying element. The Fresnel lens is configured to condense the light beams from the homogenizing element.

### BACKGROUND

1. Technical Field

The present disclosure relates to projectors, and particularly to a projector having a laser light source.

2. Description of Related Art

Laser light sources are often used in projectors to reduce the size of the projectors and improve color saturation of projected images. However, the nature of laser light makes it susceptible to interference. Projection quality is often less than satisfactory because light spots often appear in projected images due to the interference suffered by the laser light.

Therefore, what needed is a projector having a laser light source which can overcome the above shortcomings.

### BRIEF DESCRIPTION OF THE DRAWINGS

FIG. 1 is a schematic view of a projector having a laser light source according to a first embodiment.

FIG. 2 is a schematic view of a magnifying element, a homogenizing element, and a Fresnel lens of the projector of FIG. 1.

FIG. 3 is a schematic view of a projector having laser light sources according to a second embodiment.

### DETAILED DESCRIPTION

Embodiments of the present disclosure will now be described in detail below and with reference to the drawings.

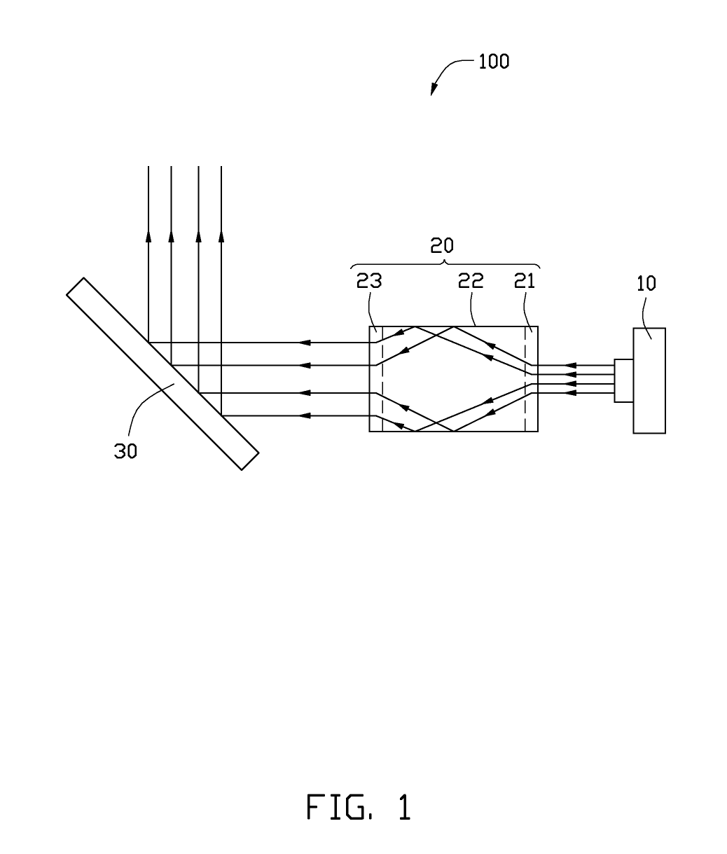

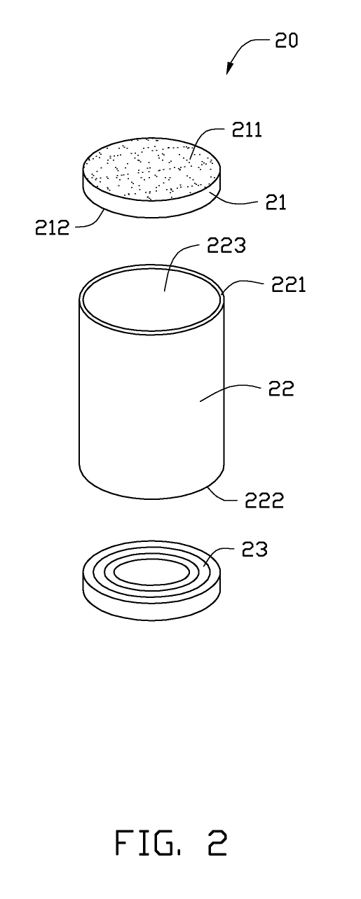

Referring to FIG. 1 and FIG. 2, a projector 100 in accordance with a first embodiment is shown. The projector 100 includes a laser light source 10, an optical component 20, and a digital micro-mirror device (DMD) 30.

The laser light source 10 is configured to emit light beams such as red light beams.

The optical component 20 is positioned to receive the light beams emitted by the laser light source 10. The optical component 20 includes a magnifying element 21, a homogenizing element 22, and a Fresnel lens 23. In this embodiment, the magnifying element 21 is a circular ground glass. The magnifying element 21 has a first surface 211 adjacent to the light source 10 and a second surface 212 opposite to the first surface 211. In this embodiment, the first surface 211 is ground or machined to have a rough texture. Thus, light beams can be efficiently dispersed by the first surface 211. It is understandable that the second surface 212 can also be ground to have a rough texture. The homogenizing element 22 is a hollow cylindrical integrator. The optical axis of the homogenizing element 22 is aligned with the optical axis of the magnifying element 21. The homogenizing element 22 includes a first end 221 adjacent to the laser light source 10, a second end 222 opposite to the first end 221, and a through hole 223 passing through the first end 221 and the second end 222. The magnifying element 21 is received in the through hole 223 adjacent to the first end 221. The Fresnel lens 23 is circular and received in the through hole 223 adjacent to the second end 222. The optical axis of the Fresnel lens 23 is aligned with the optical axis of homogenizing element 22. The light beams emitted by the laser light source 10 sequentially pass through the magnifying element 21, the homogenizing element 22, and the Fresnel lens 23.

The DMD 30 is positioned to receive emergent light beams projected from the optical component 20. The DMD 30 is a chipset provided with a plurality of micro-mirror lenses which are configured to digitally generate images.

In use of the projector 100, parallel concentrated light beams are emitted by the laser light source 10. Then, the light beams travel through the magnifying element 21. The magnifying element 21 disperses the light beams to different directions to reduce interference to the light beams. Then, the light beams are guided into the homogenizing element 22. The homogenizing element 22 homogenizes the light beams. Then the light beams travel through the Fresnel lens 23. The Fresnel lens 23 condenses the light beams. Then the light beams project to the DMD 30 to generate images.

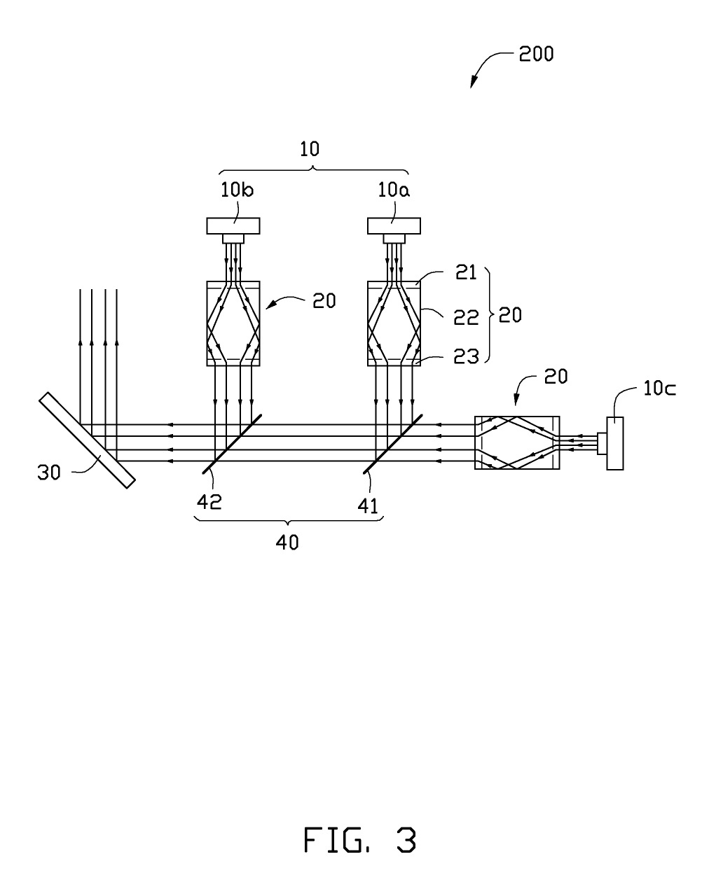

Referring to FIG. 3, a projector 200 in accordance with a second embodiment. The projector 200 includes a laser light source 10, three optical components 20, a digital micro-mirror device (DMD) 30, and a light combining component 40.

The laser light source 10 includes a first laser light source 10a, a second laser light source 10b, and a third laser light source 10c. The first laser light source 10a, the second laser light source 10b, and the third laser light source 10c are respectively configured for emitting red, green, and blue light beams.

The three optical components 20 are respectively positioned to receive the red, green, and blue light beams.

The light combining component 40 includes a first dichroic mirror 41 and a second dichroic mirror 42. The first dichroic mirror 41 is positioned to receive the red light beams and the blue light beams. The first dichroic mirror 41 is configured to reflect the red light beams and to transmit the blue light beams. The second dichroic mirror 42 is positioned to receive the green light beams from the second laser light source 10b and emergent light beams from the first dichroic mirror 41. The second dichroic mirror 34 is configured to reflect the green light beams and to transmit the red light beams and the blue light beams. The red light beams, the green light beams, and the blue lights beams are combined into white light beams. The white light beams project to the DMD 30 to generate images.

In alternative embodiments, the magnifying element 21 may be other types of optical elements such as a concave lens having a convex surface and a concave surface. The concave surface is adjacent to a corresponding laser light source and the convex surface is away from the corresponding laser light source.

It is understood that the above-described embodiment is intended to illustrate rather than limit the disclosure. Variations may be made to the embodiment without departing from the spirit of the disclosure. Accordingly, it is appropriate that the appended claims be construed broadly and in a manner consistent with the scope of the disclosure.

What is claimed is:

1. A projector, comprising:
at least one laser light source for emitting light beams; and
at least one optical component, each optical component comprising a magnifying element, a homogenizing element, and a Fresnel lens, the magnifying element, the homogenizing element and the Fresnel lens having the same optical axis, the magnifying element being positioned adjacent to a corresponding one of the at least one laser light source and configured to disperse the light beams from the corresponding laser light source, the homogenizing element being configured to homogenize the light beams from the magnifying element, and the Fresnel lens being configured to condense the light beams from the homogenizing element.

2. The projector of claim 1, wherein the homogenizing element is a hollow cylindrical integrator and comprises a first end, a second end opposite to the first end, and a through hole passing through the first end and the second end, the magnifying element is received in the through hole adjacent to the first end, the Fresnel lens is received in the through hole adjacent to the second end.

3. The projector of claim 2, wherein the magnifying element comprises a first surface and a second surface opposite to the first surface, the first surface is ground to have a rough texture and adjacent to the corresponding laser light source.

4. The projector of claim 1, wherein the magnifying element is a concave lens having a convex surface and a concave surface, the concave surface is adjacent to the corresponding laser light source and the convex surface is away from the corresponding laser light source.

5. A projector, comprising:
three laser light sources comprising a first laser light source for emitting red light beams, a second laser light source for emitting green light beams, and a third laser light source for emitting blue light beams;
three optical components, each optical component comprising a magnifying element, a homogenizing element, and a Fresnel lens having the same optical axis, the magnifying element being positioned adjacent to a corresponding one of the three laser light sources and configured to disperse the light beams from the corresponding laser light source, the homogenizing element being configured to homogenize the light beams from the magnifying element, and the Fresnel lens being configured to condense the light beams from the homogenizing element;
a first dichroic mirror aligned with the first and third laser light sources, the first dichroic mirror being configured to reflect the red light beams from the first laser light source and allow the blue light beam from the third laser light source to transmit through; and
a second dichroic mirror aligned with the second laser light source and the first dichroic mirror, the second dichroic mirror being configured to reflect the green light beams from the second laser light source and allow the red light beams and the blue light beams from the first dichroic mirror to transmit through.

6. The projector of claim 5, further comprising a DMD, the DMD being aligned with the second dichroic mirror and configured to receive the red, green and blue light beams from the second dichroic mirror to digitally generate images.

7. The projector of claim 5, wherein the homogenizing element is a hollow cylindrical integrator and comprises a first end, a second end opposite to the first end, and a through hole passing through the first end and the second end, the magnifying element is received in the through hole adjacent to the first end, the Fresnel lens is received in the through hole adjacent to the second end.

8. The projector of claim 7, wherein the magnifying element comprises a first surface and a second surface opposite to the first surface, the first surface is ground to have a rough texture and adjacent to the corresponding laser light source.

9. The projector of claim 5, wherein the magnifying element is a concave lens having a convex surface and a concave surface, the concave surface is adjacent to the corresponding laser light source and the convex surface is away from the corresponding laser light source.
